(19) United States
(12) Patent Application Publication
(10) Pub. No.: US 2025/0225878 A1
(43) Pub. Date: Jul. 10, 2025

(54) TRAVEL MANAGEMENT SYSTEM AND TRAVEL MANAGEMENT METHOD

(71) Applicant: TOYOTA JIDOSHA KABUSHIKI KAISHA, Toyota-shi Aichi-ken (JP)

(72) Inventors: Hiroya CHIBA, Fuji-shi Shizuoka-ken (JP); Daisuke KAKUMA, Susono-shi Shizuoka-ken (JP); Kento IWAHORI, Nagoya-shi Aichi-ken (JP)

(73) Assignee: TOYOTA JIDOSHA KABUSHIKI KAISHA, Toyota-shi Aichi-ken (JP)

(21) Appl. No.: 19/010,297

(22) Filed: Jan. 6, 2025

(30) Foreign Application Priority Data
Jan. 9, 2024 (JP) 2024-001281

(51) Int. Cl. G08G 1/00; G08G 1/052; G08G 1/0967; H04W 4/021

(52) U.S. Cl. CPC G08G 1/207; G08G 1/052; G08G 1/096725; H04W 4/021

(57) ABSTRACT

A travel management system manages travel of a vehicle in a predetermined area. The travel management system, with respect to a passage of the vehicle in the predetermined area, manage a traffic route defining a traveling position of the vehicle. And the travel management system detects an object in the predetermined area using a recognition sensor and execute a process of calculating a vehicle speed profile based on a positional relationship between the detected object and the traffic route. The vehicle speed profile provides a vehicle speed condition to be followed by the vehicle at each position on the traffic route. When managing travel of a target vehicle, the travel management system transmits the traveling position and the vehicle speed profile of a traveling section in which the target vehicle travels on the traffic route to a control system of the target vehicle.

### CROSS-REFERENCE TO RELATED APPLICATION

The present disclosure claims priority to Japanese Patent Application No. 2024-001281, filed on Jan. 9, 2024, the contents of which application are incorporated herein by reference in their entirety.

### TECHNICAL FIELD

The present disclosure relates to a technique for managing travel of a vehicle in a predetermined area.

### BACKGROUND ART

Patent Literature 1 discloses a travel controller that remotely controls an autonomous driving vehicle traveling in an autonomous operation area. The travel controller disclosed in Patent Literature 1 includes a sensing unit that detects an object in a detection range defined in the autonomous operation area, a route generation unit that generates a travel route of the autonomous driving vehicle traveling in the detection range using detection information of the target detected by the sensing unit, and a route transmission unit that transmits a control command based on the travel route to the autonomous driving vehicle.

In addition, the following Patent Literature 2 is a document showing the technical level of the present technical field.

### LIST OF RELATED ART

Patent Literature 1: JP 2022134583 A

Patent Literature 2: JP 2015074321 A

### SUMMARY

When managing travel of a vehicle in a predetermined area, there are normally multiple vehicles that are subject to travel management. In the technique disclosed in Patent Literature 1, it is necessary to, for each vehicle, perform a calculation that takes into account objects detected in the area. Therefore, when a large number of vehicles are subject to the travel management, the processing load may become enormous. As described above, in the related art, the technique for managing travel of a vehicle in a predetermined area has had the problem of high processing load.

An object of the present disclosure is, in view of the above problem, to reduce a processing load on a technique for managing travel of a vehicle in a predetermined area.

A first aspect of the present disclosure is directed to a travel management system for managing travel of a vehicle in a predetermined area.

The travel management system comprises:
a recognition sensor installed in the predetermined area to recognize a situation in the predetermined area; and
a management server.

The management server is configured to:
with respect to a passage of the vehicle in the predetermined area, manage a traffic route defining a traveling position of the vehicle;
detect an object in the predetermined area using the recognition sensor;
execute a process of calculating a vehicle speed profile based on a positional relationship between the detected object and the traffic route, the vehicle speed profile providing a vehicle speed condition to be followed by the vehicle at each position on the traffic route; and
when managing travel of a target vehicle, transmit the traveling position of at least a traveling section in which the target vehicle travels on the traffic route and the vehicle speed profile of the traveling section to a control system of the target vehicle.

A second aspect of the present disclosure is directed to a travel management method for managing travel of a vehicle in a predetermined area in cooperation with one or more processors and one or more memories.

The travel management method includes:
with respect to a passage of the vehicle in the predetermined area, manage a traffic route defining a traveling position of the vehicle;
detect an object in the predetermined area using a recognition sensor;
execute a process of calculating a vehicle speed profile based on a positional relationship between the detected object and the traffic route, the vehicle speed profile providing a vehicle speed condition to be followed by the vehicle at each position on the traffic route; and
when managing travel of a target vehicle, transmit the traveling position of at least a traveling section in which the target vehicle travels on the traffic route and the vehicle speed profile of the traveling section to a control system of the target vehicle.

According to the present disclosure, a traffic route that defines a traveling position of a vehicle is managed, and a vehicle speed profile is calculated based on a positional relationship between a detected object detected in a predetermined area and the traffic route. And, in travel management of the target vehicle, the traveling position and the vehicle speed profile of a traveling section of the traffic route where the target vehicle travels are transmitted to a control system of the target vehicle. It is thus possible to perform the travel management of each vehicle without performing a calculation that takes into account objects detected for each vehicle. As a result, even when a large number of vehicles are subject to the travel management, it is possible to suppress an increase in the processing load and reduce the processing load.

### BRIEF DESCRIPTION OF DRAWINGS

FIG. 1 is a conceptual diagram for explaining an example of travel management of a vehicle performed by a travel management system as an AVP system;

FIG. 2 is a diagram showing an example of a configuration of a travel management system according to an embodiment;

FIG. 3 is a block diagram showing an example of a functional configuration of a management server related to a function of transmitting instruction information;

FIG. 4 is a conceptual diagram showing an example of traffic route data;

FIG. 5 is a conceptual diagram showing an example of a vehicle speed profile;

FIG. 6 is a diagram showing an example of data management of the vehicle speed profile;

FIG. 7 is a flowchart showing a processing flow of processing executed by the management server with respect to the function of transmitting the instruction information;

FIG. 8 is a block diagram showing an example of a functional configuration of the management server related to a function of calculating the vehicle speed profile;

FIG. 9A is a diagram showing an example of the vehicle speed profile calculated by a vehicle speed profile calculation unit;

FIG. 9B is a diagram showing another example of the vehicle speed profile calculated by the vehicle speed profile calculation unit;

FIG. 9C is a diagram showing another example of the vehicle speed profile calculated by the vehicle speed profile calculation unit;

FIG. 9D is a diagram showing another example of the vehicle speed profile calculated by the vehicle speed profile calculation unit;

FIG. 10 is a flowchart showing a processing flow of processing executed by the management server with respect to the function of calculating the vehicle speed profile;

FIG. 11 is a block diagram showing an example of a functional configuration of the management server related to dynamic update of traffic route data;

FIG. 12 is a diagram showing an example of the traffic route data updated by a traffic route updating unit; and

FIG. 13 is a flowchart showing a processing flow of processing executed by the management server with respect to the dynamic update of the traffic route data.

### DETAILED DESCRIPTION

### 1. Travel Management System

The travel management system according to the present embodiment manages travel of a vehicle in a predetermined area. The vehicle in the predetermined area travels based on an instruction from the travel management system.

The predetermined area to which the travel management system is applied is not particularly limited. Examples of the predetermined area include a parking lot, a factory site, a warehouse, and a town. The predetermined area may be a part of these areas.

The travel management system according to the present embodiment can be used as a system that provides various functions depending on the type of the predetermined area or the vehicle. For example, when the predetermined area is a parking lot, the travel management system may be used as an AVP (automated valet parking) system that provides AVP. That is, in this case, the travel management system provides a function of automatically performing the entry and exit of a vehicle in the parking lot without user operation. In other cases, for example, when the predetermined area is a warehouse, the travel management system may be used as a system that provides a function of managing travel of an unmanned transport vehicle that carries goods in and out of the warehouse.

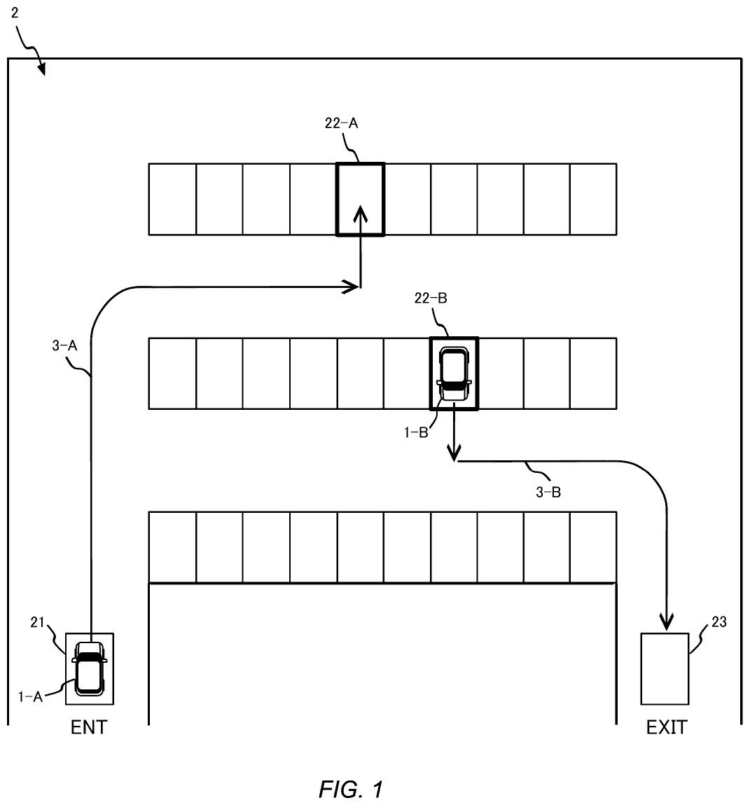

FIG. 1 is a conceptual diagram for explaining an example of travel management of a vehicle 1 performed by the travel management system as an AVP system. FIG. 1 shows a case where the travel management system performs the travel management of vehicles 1 (1-A and 1-B) in a parking lot 2.

The travel management of the vehicle 1-A relates to the entry in the AVP. In this case, the travel management system performs the travel management of the vehicle 1-A such that the vehicle 1-A travels from an entry position 21 to a parking position 22-A. A route 3-A indicates an example of travel of the vehicle 1-A realized by the travel management by the travel management system.

The travel management of the vehicle 1-B relates to the exit in the AVP. In this case, the travel management system performs the travel management of the vehicle 1-B such that the vehicle 1-B travels from the parking position 22-B to the exit position 23. A route 3-B indicates an example of travel of the vehicle 1-B realized by the travel management by the travel management system.

As described above, the travel management of the vehicle 1 by the travel management system according to the present embodiment includes instructing the traveling position of the vehicle 1.

By the way, it is conceivable that there are some objects other than the vehicle 1 that is subject to the travel management in the predetermined area to which the travel management system is applied. For example, there may be a pedestrian or a fallen object in the parking lot 2. The travel management system performs the travel management of the vehicle 1 taking these objects into account. More specifically, the travel management system performs the travel management of the vehicle 1 so as to reduce the vehicle speed or temporarily stop the vehicle 1 near these objects.

As described above, the travel management of the vehicle 1 by the travel management system according to the present embodiment includes instructing a vehicle speed condition to be followed by the vehicle 1 with respect to the traveling position of the vehicle 1, taking into account objects existing in the predetermined area.

The travel management system normally performs travel management of a plurality of vehicles 1 in a predetermined area. Therefore, the travel management system, for each vehicle 1, performs the travel management taking into account objects that exist in the predetermined area. Conventionally, when performing travel management taking into account each object in a predetermined area for each vehicle, there is a problem of high processing load when a large number of vehicles 1 are subject to the travel management. The travel management system according to the present embodiment makes it possible to suppress an increase in the processing load even when a large number of vehicles 1 are subject to the travel management. Hereinafter, the travel management system according to the present embodiment will be described in detail.

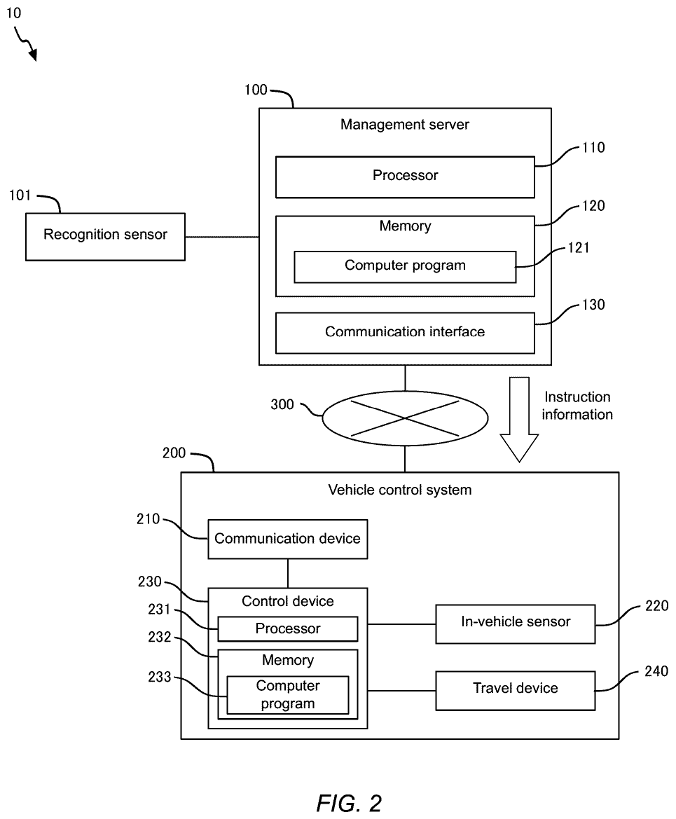

FIG. 2 is a diagram showing an example of a configuration of a travel management system 10 according to the present embodiment. The travel management system 10 includes a management server 100 that communicates with a vehicle control system 200 of the vehicle 1 and a recognition sensor 101 that is communicably connected to the management server 100.

The recognition sensor 101 may be installed in a predetermined area to which the travel management system 10 is applied. The recognition sensor 101 recognizes a situation in the predetermined area. The recognition sensor 101 is configured by a sensor such as a camera, a LiDAR, or a radar, or a combination of one or more of these sensors. The recognition sensor 101 at least detects an object in the predetermined area and acquires information of the detected object. For example, the recognition sensor 101 may acquire a position of the detected object in the predetermined area. Further, for example, the recognition sensor 101 acquires a state (e.g., a speed, an acceleration, or the like) of the detected object. Further, for example, the recognition sensor 101 acquires a classification of the detected object (e.g., a pedestrian, a bicycle, a fallen object, or the like). Further, for example, the recognition sensor 101 acquires an attribute (e.g., a moving object, a stationary object, a size, or the like) of the detected object. The information acquired by the recognition sensor 101 is transmitted to the management server 100.

The management server 100 generates instruction information for travel management of the vehicle 1 and transmits the generated instruction information to the vehicle control system 200 of the vehicle 1.

The management server 100 includes a processor 110, a memory 120, and a communication interface 130.

The processor 110 executes various processes. The processor 110 is configured by, for example, a general-purpose processor, a special-purpose processor, a CPU (central processing unit), a GPU (graphics processing unit), an ASIC (application specific integrated circuit), a FPGA (field-programmable gate array), an integrated circuit, a conventional circuit, or a combination of one or more of these. The processor 110 may also be referred to as circuitry or processing circuitry. “Circuitry” is hardware programmed to implement the functions described in the present disclosure or hardware that performs the functions described in the present disclosure.

The memory 120 stores various information necessary for the processor 110 to execute processing. The memory 120 is configured by a recording medium such as a RAM (random access memory), a ROM (read only memory), a SSD (solid state drive), a HDD (hard disk drive), or the like. The memory 120 stores a computer program 121. The computer program 121 may be recorded in a computer-readable recording medium. The computer program 121 describes processing to be executed by the processor 110. The functions of the management server 100 are realized by cooperation of the processor 110 executing the computer program 121 and the memory 120.

The communication interface 130 is an interface for connecting to a communication network 300 and communicating with an external device of the management server 100. The communication network 300 is configured by, for example, the Internet, a mobile communication network, a LAN (local area network), or the like. The management server 100 transmits and receives information to and from the vehicle control system 200 via the communication interface 130. In addition, the management server 100 may transmit and receive information to and from a user device (e.g., a smartphone, a tablet) of a user via the communication interface 130.

The vehicle control system 200 is a system that controls the vehicle 1.

The vehicle control system 200 includes a communication device 210, an in-vehicle sensor 220, a control device 230, and a travel device 240.

The communication device 210 is connected to the communication network 300 to transmit and receive information. The vehicle control system 200 transmits and receives information to and from the management server 100 via the communication device 210. The communication device 210 receives at least the instruction information from the management server 100. The information received by the communication device 210 is transmitted to the control device 230.

The in-vehicle sensor 220 is mounted on the vehicle 1 and detects traveling environment of the vehicle 1. The in-vehicle sensor 220 acquires information such as a situation around the vehicle 1 (e.g., other vehicles, a white line, an obstacle) and a traveling state of the vehicle 1 (e.g., a vehicle speed, an acceleration/deceleration, and a yaw rate). Examples of the in-vehicle sensor 220 include a camera, a radar, a LiDAR, a wheel speed sensor, an IMU (inertial measurement unit) or a GNSS (global navigation satellite system) sensor. The detection information acquired by the in-vehicle sensor 220 is transmitted to the control device 230.

The control device 230 is a computer that controls the vehicle 1 based on various kinds of information. In particular, the control device 230 has a function of controlling the vehicle 1 such that the vehicle 1 travels in accordance with the instruction information. The control device 230 acquires the instruction information from the management server 100 via the communication device 210. And the control device 230 acquires the detection information of the traveling environment of the vehicle 1 from the in-vehicle sensor 220. Then, the control device 230 generates a control signal based on the detection information so as to realize the traveling of the vehicle 1 in accordance with the instruction information. The control signal generated by the control device 230 is transmitted to the travel device 240.

The control device 230 includes a processor 231 and a memory 232. The processor 231 executes various processes. The processor 231 is configured by, for example, a general-purpose processor, a special-purpose processor, a CPU, a GPU, an ASIC, a FPGA, an integrated circuit, a conventional circuit, or a combination of one or more of these. The memory 232 stores various information necessary for the processor 231 to execute processing. The memory 232 is configured by a recording medium such as a RAM, a ROM, a SSD, a HDD, or the like. The memory 232 stores a computer program 233. The computer program 233 may be recorded in a computer-readable recording medium. The computer program 233 describes processing to be executed by the processor 231. The functions of the control device 230 are realized by cooperation of the processor 231 executing the computer program 233 and the memory 232.

The travel device 240 is mounted on the vehicle 1 and provides a traveling function of the vehicle 1. The travel device 240 includes a drive device, a braking device, and a steering device. The drive device generates a driving force. Examples of the drive device include an engine, an electric motor, or the like. The braking device generates a braking force. The steering device steers the wheels of the vehicle 1. Each device may include an actuator controllable by the control device 230. The travel device 240 operates the drive device, the braking device, and the steering device in accordance with the control signal acquired from the control device 230. In this way, the vehicle 1 travels in accordance with the instruction information.

In the vehicle control system 200, the communication device 210 and the control device 230 may be provided outside the vehicle 1. For example, the communication device 210 and the control device 230 may be provided as a part of infrastructure equipment in the predetermined area. In this case, the control device 230 may be configured to transmit and receive information to and from the in-vehicle sensor 220 and the travel device 240 of each vehicle 1 via the communication device 210.

As described above, the travel management system 10 according to the present embodiment is configured. Hereinafter, the functions of the management server 100 will be described in more detail based on the above-described configuration.

### 2. Function of Management Server

### 2.1. Transmission of Instruction Information

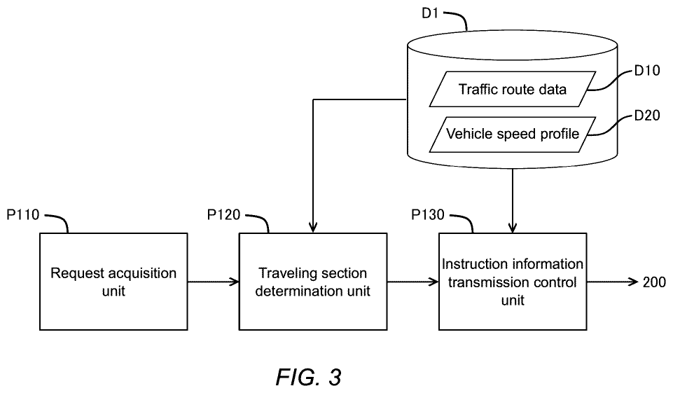

In the travel management system 10, the management server 100 generates the instruction information for travel management of the vehicle 1 and transmits the generated instruction information to the vehicle control system 200 of the vehicle 1. FIG. 3 is a block diagram showing an example of a functional configuration of the management server 100 related to a function of transmitting the instruction information. The management server 100 manages a management database D1. The management database D1 is stored in, for example, the memory 120.

The management database D1 includes a traffic route data D10 and a vehicle speed profile D20.

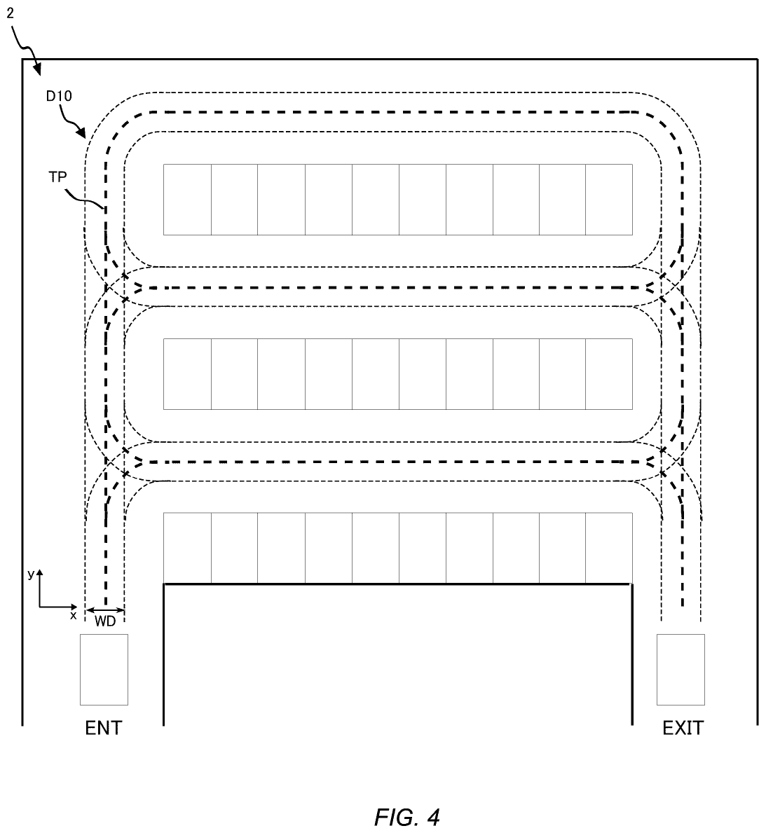

The traffic route data D10 is data of a traffic route that defines a traveling position of the vehicle 1 with respect to a passage of the vehicle 1 in the predetermined area. FIG. 4 is a conceptual diagram showing an example of the traffic route data D10 when the predetermined area is the parking lot 2 shown in FIG. 1. In FIG. 4, a traveling position TP (thick dashed line) defined by the traffic route data D10 is shown. The traffic route data D10 can manage the traveling position TP by the two dimensional coordinates (x, y) that define the position in the parking lot 2. Alternatively, the traffic route data D10 may manage the traveling position TP by using a graph data that further includes a traveling direction of the vehicle 1 at each point.

Further, the traffic route data D10 may manage information of a route width WD of the traffic route as shown in FIG. 4. At this time, the traffic route represented by the traffic route data D10 is an area (area surrounded by a thin dashed line) determined by the traveling position TP and the route width WD. The route width WD is set to, for example, a value obtained by adding a predetermined margin to the vehicle width of the vehicle 1 for which the travel management system 10 performs travel management.

The traffic route data D10 is created in advance according to a predetermined area to which the travel management system 10 is applied. However, the management server 100 may be configured to be able to update the traffic route data D10 as appropriate. For example, the management server 100 receives new traffic route data D10 via the communication network 300. The management server 100 updates the traffic route data D10 of the management database D1 to the received new traffic route data D10.

The vehicle speed profile D20 is data that provides a vehicle speed condition to be followed by the vehicle 1 at each position on the traffic route represented by the traffic route data D10. The vehicle speed condition can be adopted as appropriate depending on the form of travel management of the vehicle 1 performed by the travel management system 10. Typically, the vehicle speed condition is a maximum vehicle speed or a target vehicle speed of the vehicle 1. In the following description, the vehicle speed condition is assumed to be the maximum vehicle speed of vehicle 1. That is, the vehicle speed profile D20 provides the maximum vehicle speed of the vehicle 1 at each position on the traffic route represented by the traffic route data D10. However, when the vehicle speed condition is set to the target vehicle speed, the “maximum vehicle speed” in the following description may be replaced with the “target vehicle speed” as appropriate.

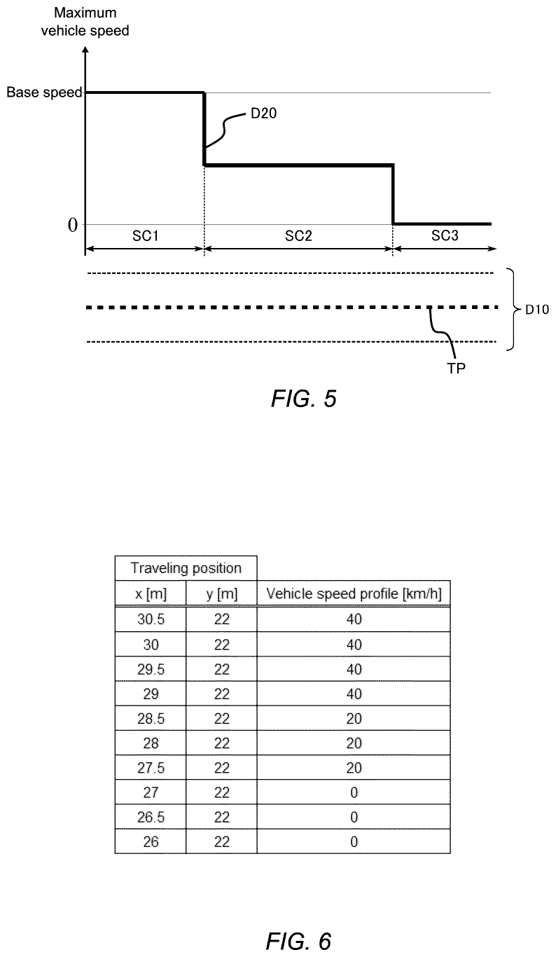

FIG. 5 is a conceptual diagram showing an example of the vehicle speed profile D20 for a portion of the traffic route data D10. As shown in FIG. 5, the vehicle speed profile D20 provides the maximum vehicle speed from a base speed to zero. In the example shown in FIG. 5, the vehicle speed profile D20 sets the maximum vehicle speed of the section SC1 of the traffic route to the base speed. And the vehicle speed profile D20 sets the maximum vehicle speed of the section SC2 of the traffic route to a speed (suppressed speed) lower than the base speed. And the vehicle speed profile D20 sets the maximum vehicle speed of the section SC3 of the traffic route to zero.

The vehicle speed profile D20 can be managed by associating the maximum vehicle speed with each point of the traffic route. FIG. 6 shows an example of data of the vehicle speed profile D20. In the example shown in FIG. 6, the traveling position TP in the traffic route is managed by coordinate data.

The vehicle speed profile D20 is calculated based on a positional relationship between an object in the predetermined area and the traffic route. The calculation of the vehicle speed profile D20 will be described later.

Refer to FIG. 3 again. The management server 100 includes, as functional blocks, a request acquisition unit P110, a traveling section determination unit P120, and an instruction information transmission control unit P130. These functional blocks are realized by, for example, cooperation between the processor 110 that executes the computer program 121 and the memory 120.

The request acquisition unit P110 acquires a request related to travel management of the vehicle 1 via the communication network 300. The acquired request identifies vehicle 1 (target vehicle) that is a target of travel management. Also, the acquired request identifies the content of the travel management. For example, the request acquisition unit P110 acquires a request for entry of the vehicle 1 from an user. The request acquisition unit P110 may acquire a request from the vehicle 1.

The traveling section determination unit P120 accesses the management database D1 and refers to the traffic route data D10. Then, the traveling section determination unit P120 determines a traveling section in which the target vehicle travels on the traffic route in response to the request acquired by the request acquisition unit P110. For example, when the request is entry of the vehicle 1 from an user, the traveling section determination unit P120 determines that the section from the entry position 21 to the parking position 22-A on the traffic route is the traveling section of the target vehicle.

The instruction information transmission control unit P130 generates the instruction information to be transmitted to the vehicle control system 200 of the target vehicle. The instruction information transmission control unit P130 accesses the management database D1 and refers to the traffic route data D10 and the vehicle speed profile D20. And the instruction information transmission control unit P130 acquires the traveling section determined by the traveling section determination unit P120. Then, the instruction information transmission control unit P130 generates the traveling position TP and the vehicle speed profile D20 of the acquired traveling section as the instruction information. The instruction information transmission control unit P130 transmits the generated instruction information to the vehicle control system 200 of the target vehicle via the communication network 300.

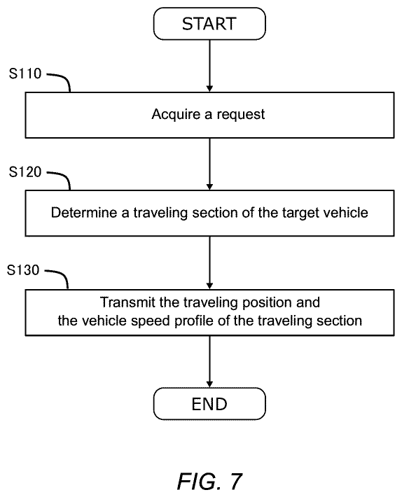

FIG. 7 is a flowchart showing a processing flow of processing executed by the management server 100 with respect to the function of transmitting the instruction information.

First, in step S110, the management server 100 acquires a request related to the travel management of the vehicle 1 via the communication network 300.

Next, in step S120, the management server 100 determines the traveling section of the target vehicle from the acquired request.

Next, in step S130, the management server 100 accesses the management database D1 and acquires the traveling position TP and the vehicle speed profile D20 of the traveling section determined in step S120. Then, the management server 100 transmits the traveling position TP and the vehicle speed profile D20 of the acquired traveling section as the instruction information. As will be described later, the vehicle speed profile D20 is changed in response to an object detected in the predetermined area. Therefore, the management server 100 may execute the process related to the step S130 every time the vehicle speed profile D20 is changed.

As described above, the management server 100 transmits the instruction information to the vehicle control system 200 of the target vehicle. The instruction information includes the traveling position TP and the vehicle speed profile D20 of the traveling section in which the target vehicle travels on the traffic route. Accordingly, the vehicle control system 200 of the target vehicle controls the traveling of the target vehicle such that the target vehicle satisfies the traveling position TP and the vehicle speed profile D20 of the instruction information.

### 2.2. Calculation of Vehicle Speed Profile

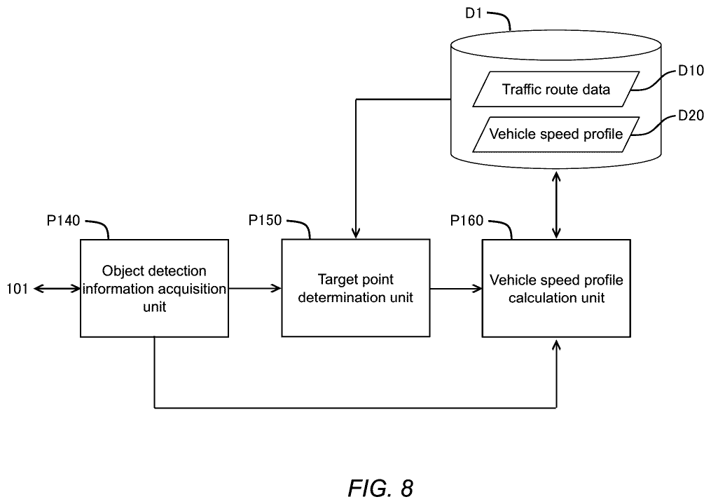

The management server 100 detects an object in the predetermined area using the recognition sensor 101. The management server 100 calculates and manages the vehicle speed profile D20 based on a positional relationship between the detected object and the traffic route. FIG. 8 is a block diagram showing an example of a functional configuration of the management server 100 related to a function of calculating the vehicle speed profile D20.

In FIG. 8, the management server 100 includes, as functional blocks, an object detection information acquisition unit P140, a target point determination unit P150, and a vehicle speed profile calculation unit P160. These functional blocks are realized by, for example, cooperation between the processor 110 that executes the computer program 121 and the memory 120.

The object detection information acquisition unit P140 acquires detection information of an object in the predetermined area detected by the recognition sensor 101.

The target point determination unit P150 acquires the detection information from the object detection information acquisition unit P140. And the target point determination unit P150 accesses the management database D1 and refers to the traffic route data D10. The target point determination unit P150 determines a target point on the traffic route for the detected object based on the detection information. The target point is typically a point on the traffic route at which a distance to the detected object is the minimum. The target point determination unit P150 further calculates a distance between the detected object and the target point. When multiple objects are detected in the predetermined area, the target point determination unit P150 may determine the target point for each detected object. Further, the target point determination unit P150 may also calculate the distance between each detected object and the target point for each detected object.

The vehicle speed profile calculation unit P160 calculates the vehicle speed profile D20. The calculation of the vehicle speed profile D20 by the vehicle speed profile calculation unit P160 is performed as follows.

The vehicle speed profile calculation unit P160 acquires the detection information from the object detection information acquisition unit P140. The vehicle speed profile calculation unit P160 calculates, when there is no detected object (when no object is detected in the predetermined area), the vehicle speed profile D20 in which the maximum vehicle speed at each point on the traffic route is the base speed. That is, the base speed is the maximum vehicle speed when the vehicle 1 travels in a situation where the detected object does not need to be considered.

When the detected object exists in the predetermined area, the vehicle speed profile calculation unit P160 acquires the target point and the distance between the detected object and the target point from the target point determination unit P150. And the vehicle speed profile calculation unit P160 calculates the vehicle speed profile D20 such that the maximum vehicle speed of a section (target section) including the target point varies depending on the distance between the detected object and the target point with reference to the base speed. The target section is typically a section within a certain distance from the target point.

In detail, the vehicle speed profile calculation unit P160 calculates, when the distance between the detected object and the target point is equal to or less than a first threshold, the vehicle speed profile D20 such that the maximum vehicle speed of the target section is set to a suppressed speed lower than the base speed. That is, in this case, the vehicle 1 decelerates until the vehicle speed becomes equal to or lower than the suppressed speed when the vehicle 1 travels in the target section. Further, the vehicle speed profile calculation unit P160 may calculate the vehicle speed profile D20 such that the suppressed speed is decreased as the distance between the detected object and the target point becomes shorter.

Further, the vehicle speed profile calculation unit P160 calculates, when the difference between the detected object and the target point is equal to or less than a second threshold smaller than the first threshold, the vehicle speed profile D20 such that the maximum vehicle speed of the target section is set to zero. That is, in this case, the vehicle 1 is temporarily stopped at the target section.

When the difference between the detected object and the target point is greater than the first threshold, the vehicle speed profile calculation unit P160 maintains the maximum vehicle speed of the target section at the base speed. That is, in this case, the vehicle 1 travels at the normal speed even in the target section. Therefore, when the distance between the detected object and the target point being greater than the first threshold, it means that the detected object is sufficiently far away from the traffic route.

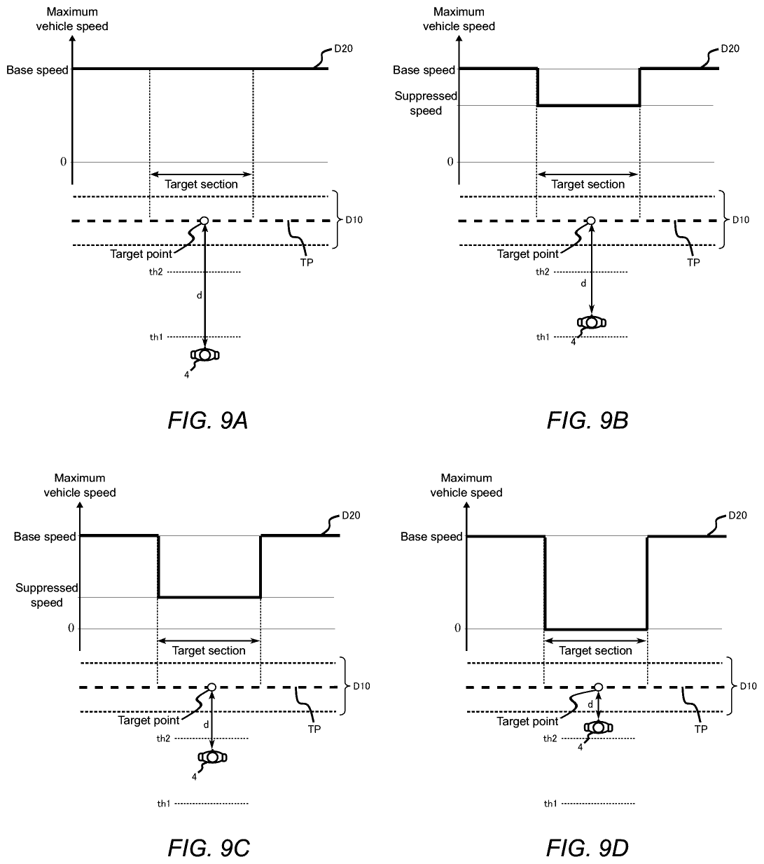

FIGS. 9A to 9D are diagrams showing an example of the vehicle speed profile D20 calculated by the vehicle speed profile calculation unit P160. In each of FIGS. 9A to 9D, a detected object 4, a target point, a target section, a distance d between the detected object and the target point, a first threshold th1, and a second threshold th2 are shown.

In FIG. 9A, the distance d is greater than the first threshold th1. Therefore, in the vehicle speed profile D20, the maximum vehicle speed of the target section remains the base speed. In FIG. 9B, the distance d is less than the first threshold th1. Therefore, in the vehicle speed profile D20, the maximum vehicle speed of the target section is a suppressed speed lower than the base speed. In FIG. 9C, the distance d is also less than the first threshold th1. In FIG. 9C, the distance d is shorter than that in FIG. 9B. Therefore, in the vehicle speed profile D20, the maximum vehicle speed of the target section is a suppressed speed lower than the base speed. Further, the suppressed speed of the vehicle speed profile D20 of FIG. 9C is lower than the suppressed speed of the vehicle speed profile D20 of FIG. 9B. In FIG. 9D, the distance d is less than the second threshold th2. Therefore, in the vehicle speed profile D20, the maximum vehicle speed of the target section is zero.

The vehicle speed profile calculation unit P160 may be further configured to acquire a classification of the detected object 4 from the detection information, and change at least one of the first threshold value, the second threshold value, and the suppressed speed depending on the classification of the detected object 4. For example, when the classification of the detected object 4 is a bicycle, the first threshold th1 and the second threshold th2 are increased and the suppressed speed is decreased, compared to when the classification of the detected object 4 is a pedestrian. This causes the vehicle 1 to decelerate significantly at an earlier stage when a bicycle approaches the traffic route than when a pedestrian approaches the traffic route. And the vehicle 1 is temporarily stopped at an earlier stage. Also, for example, when the classification of the detected object 4 is a fallen object, the first threshold and the second threshold are set to be smaller than those when the classification of the detected object 4 is a person. Thereby, when a fallen object is close to the traffic route, the deceleration and the temporary stop of the vehicle 1 can be determined more gently than when the person is close to the traffic route.

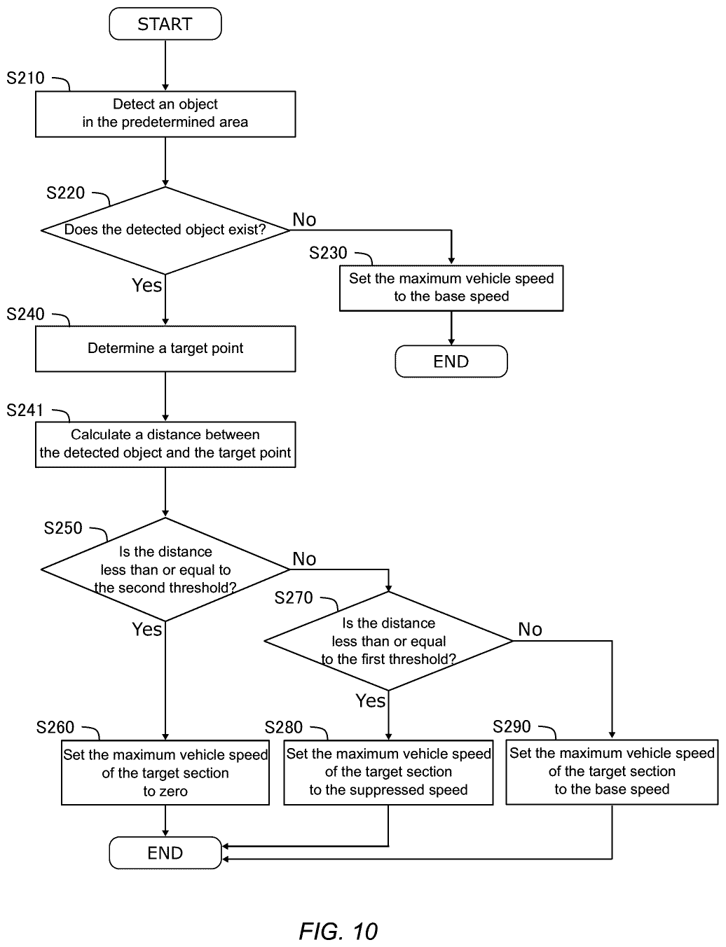

FIG. 10 is a flowchart showing a processing flow of processing executed by the management server 100 with respect to the function of calculating the vehicle speed profile D20. The processing flow shown in FIG. 10 is repeatedly executed at a predetermined processing cycle.

First, in step S210, the management server 100 detects an object in the predetermined area using the recognition sensor 101.

When the detected object 4 does not exist (step S220; No), the management server 100 calculates the vehicle speed profile D20 in which the maximum vehicle speed at each point on the traffic route is set to the base speed (step S230).

When the detected object 4 exists (step S220; Yes), the management server 100 determines a target point on the traffic route for the detected object 4 (step S240). Next, the management server 100 calculates a distances between the detected object 4 and the target point (step S241).

When the distance between the detected object 4 and the target point is equal to or less than the second threshold (step S250; Yes), the management server 100 calculates the vehicle speed profile D20 such that the maximum vehicle speed of the target section is set to zero (step S260).

When the distance between the detected object 4 and the target point is larger than the second threshold (step S250; No) and is equal to or smaller than the first threshold (step S270; Yes), the management server 100 calculates the vehicle speed profile D20 such that the maximum vehicle speed of the target section is set to the suppressed speed (step S280).

When the distance between the detected object 4 and the target point is larger than the first threshold (step S250; No, step S270; No), the management server 100 calculates the vehicle speed profile D20 such that the maximum vehicle speed of the target section is set to the base speed (step S290).

In this way, the management server 100 calculates the vehicle speed profile D20 based on the positional relationship between the detected object 4 and the traffic route.

### 3. Effect

As described above, according to the travel management system 10 of the present embodiment, in the travel management of the target vehicle, the traveling position TP and the vehicle speed profile D20 of the traveling section in which the target vehicle travels on the traffic route are transmitted to the vehicle control system 200 of the target vehicle. The vehicle control system 200 controls travel of the target vehicle such that the target vehicle satisfies the transmitted traveling position TP and vehicle speed profile D20. In particular, the vehicle speed profile D20 is calculated based on the positional relationship between the detected object 4 detected in the predetermined area and the traffic route. In this way, the travel management system 10 of the present embodiment updates the vehicle speed profile D20 for the detected object 4, thereby performing the travel management of the vehicle 1 taking the detected object 4 into consideration. Therefore, according to the travel management system 10 of the present embodiment, since the updated vehicle speed profile D20 is transmitted to each vehicle 1, there is no need to perform a calculation that takes into account the detected object 4 for each vehicle 1. As a result, even when a large number of vehicles are subject to the travel management, the travel management system 10 of the present embodiment makes it possible to suppress an increase in the processing load and reduce the processing load.

### 4. Modification: Dynamic Update of Traffic Route Data

In the vehicle speed profile D20, when the maximum vehicle speed in a certain section is set to the suppressed speed or zero, the vehicle 1 to be subject to travel management is decelerated or temporarily stopped in that section. That is, it will reduce the availability of the vehicle 1. By the way, the vehicle speed profile D20 is calculated based on a positional relationship between the detected object 4 and the traffic route. Therefore, it is expected that the section in which the maximum vehicle speed is set to the suppressed speed or zero in the vehicle speed profile D20 can be reduced by changing the traffic route.

Then, in the travel management system 10 according to the present embodiment, the management server 100 may be configured to further dynamically update the traffic route data D10 as follows.

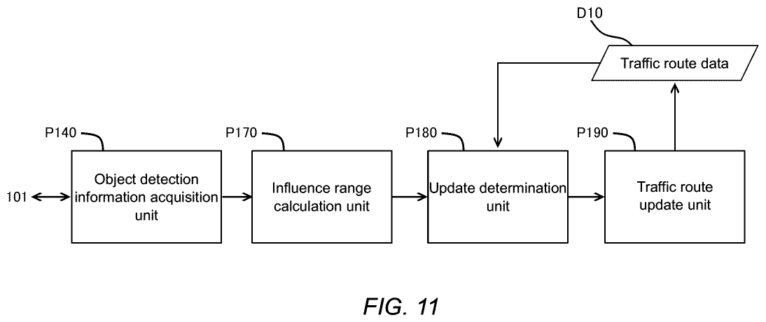

FIG. 11 is a block diagram showing an example of a functional configuration of the management server 100 related to dynamic update of the traffic route data D10.

In FIG. 11, the management server 100 includes, as functional blocks, the object detection information acquisition unit P140, an influence range calculation unit P170, an update determination unit P180, and a traffic route update unit P190. These functional blocks are realized by, for example, cooperation between the processor 110 that executes the computer program 121 and the memory 120.

The object detection information acquisition unit P140 is the same as that described in FIG. 8. The object detection information acquisition unit P140 acquires detection information of an object in the predetermined area detected by the recognition sensor 101.

The influence range calculation unit P170 acquires the detection information from the object detection information acquisition unit P140. The influence range calculation unit P170 calculates an influence range in which the detected object 4 influences travel of the vehicle 1 from the detection information. For example, when the detected object 4 is a moving object, the influence range calculation unit P170 calculates a movement prediction range of the moving object as the influence range. The movement prediction range can be calculated from the speed and acceleration of the detected object 4. Also, for example, when the detected object 4 is a stationary object, the influence range calculation unit P170 calculates the influence range based on the size of the stationary object.

The update determination unit P180 determines whether or not to update the traffic route data D10. The update determination unit P180 acquires the influence range of the detected object 4 from the influence range calculation unit P170. The update determination unit P180 first determines whether the influence range of the detected object 4 is in contact with the traffic route. When the influence range of the detected object 4 is not in contact with the traffic route, the update determination unit P180 determines not to update the traffic route data D10. When the influence range of the detected object 4 is in contact with the traffic route, the update determination unit P180 next refers to the traffic route data D10 to determine whether or not a change of moving the traveling position TP of a contacting section on the traffic route in a direction away from the influence range of the detected object 4 is possible. For example, when there is a margin for moving the traveling position TP in a direction away from the influence range of the detected object 4 in the contacting section, it is determined that the change is possible. When it is determined that the change is possible, the update determination unit P180 determines to update the traffic route data D10.

The traffic route update unit P190 executes processing when the update determination unit P180 determines that the traffic route data D10 should be update. The traffic route update unit P190 updates the traffic route data D10 such that the traveling position TP of the contacting section moves in a direction away from the influence range of the detected object 4.

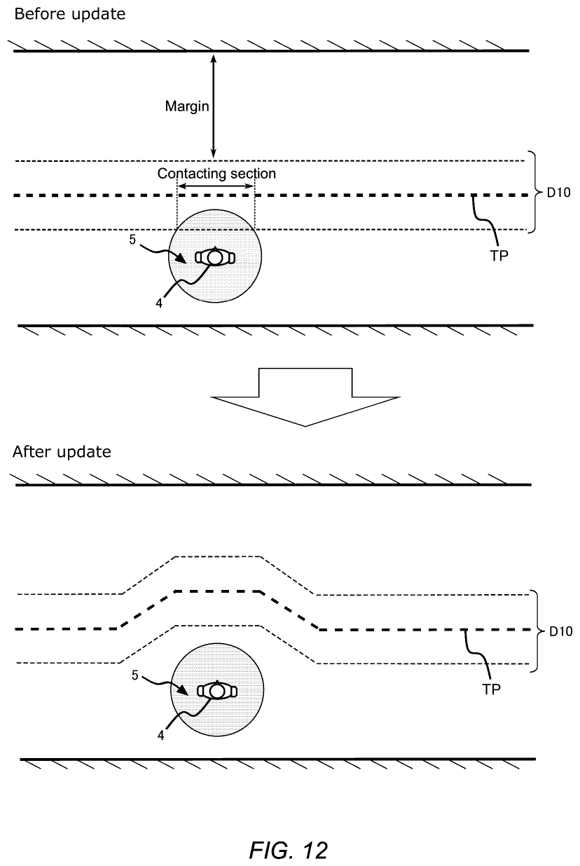

FIG. 12 is a diagram showing an example of the traffic route data D10 updated by the traffic route update unit P190. Before update, the influence range 5 of the detected object 4 is in contact with the traffic route. On the other hand, there is a margin for moving the traveling position TP in a direction away from the influence range 5. Therefore, the update determination unit P180 determines to update the traffic route data D10. After update, the traveling position TP of the contacting section moves in a direction away from the influence range 5. As a result, as shown in FIG. 12, the detected object 4 can be kept away from the traffic route. That is, it is expected that the distance between the detected object 4 and the target point on the traffic route becomes longer.

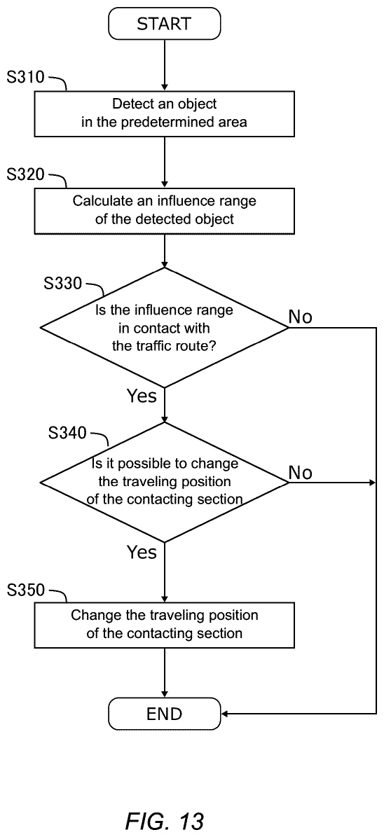

FIG. 13 is a flowchart showing a processing flow of processing executed by the management server 100 with respect to the dynamic update of the traffic route data D10. The processing flow shown in FIG. 13 is repeatedly executed at a predetermined processing cycle.

First, in step S310, the management server 100 detects an object in the predetermined area using the recognition sensor 101.

Next, in step S320, the management server 100 calculates an influence range 5 of the detected object 4 based on the detection information from the recognition sensor 101.

Next, in step S330, the management server 100 refers to the traffic route data D10 and determines whether or not the influence range 5 is in contact with the traffic route. When the influence range 5 is not in contact with the traffic route (step S330; No), the management server 100 ends the current processing without updating the traffic route data D10.

When the influence range 5 is in contact with the traffic route (step S330; Yes), the management server 100 determines whether or not the change of moving the traveling position TP of the contacting section on the traffic route in a direction away from the influence range 5 (step S340). When the change is not possible (step S340; No), the management server 100 ends the current processing without updating the traffic route data D10.

When the change is possible (step S340; Yes), the management server 100 updates the traffic route data D10 to change the traveling position TP of the contacting section such that the traveling position TP moves in a direction away from the influence range 5 (step S350).

As described above, according to the travel management system 10 of the modification, the traffic route is updated such that the traveling position TP of the contacting section moves in a direction away from the influence range 5 of the detected object 4. This makes it possible to keep the detected object 4 away from the traffic route. That is, it is expected that the distance between the detected object 4 and the target point on the traffic route becomes longer. As a result, it is possible to reduce a section in which the maximum vehicle speed is set to the suppressed speed or zero in the vehicle speed profile D20.

What is claimed is:

1. A travel management system for managing travel of a vehicle in a predetermined area, comprising:
a recognition sensor installed in the predetermined area to recognize a situation in the predetermined area; and
a management server configured to:
with respect to a passage of the vehicle in the predetermined area, manage a traffic route defining a traveling position of the vehicle;
detect an object in the predetermined area using the recognition sensor;
execute a process of calculating a vehicle speed profile based on a positional relationship between the detected object and the traffic route, the vehicle speed profile providing a vehicle speed condition to be followed by the vehicle at each position on the traffic route; and
when managing travel of a target vehicle, transmit the traveling position of at least a traveling section in which the target vehicle travels on the traffic route and the vehicle speed profile of the traveling section to a control system of the target vehicle.

2. The travel management system according to claim 1, wherein
the vehicle speed condition is a maximum vehicle speed or a target vehicle speed of the vehicle.

3. The travel management system according to claim 2, wherein
in the process of calculating the vehicle speed profile, the management server is configured to:
when the object is not detected, set the maximum vehicle speed or the target vehicle speed to a base speed; and
when a distance between the detected object and a target point on the traffic route is equal to or less than a first threshold, set the maximum vehicle speed or the target vehicle speed in a target section including the target point on the traffic route to a suppressed speed lower than the base speed.

4. The travel management system according to claim 3, wherein
in the process of calculating the vehicle speed profile, the management server is configured to, when the distance is equal to or less than the first threshold, decrease the suppressed speed as the distance becomes shorter.

5. The travel management system according to claim 3, wherein
in the process of calculating the vehicle speed profile, the management server is configured to, when the distance is equal to or less than a second threshold smaller than the first threshold, set the maximum vehicle speed or the target vehicle speed in the target section to zero.

6. The travel management system according to claim 5, wherein
the management server is further configured to:
acquire a classification of the object; and
change at least one of the first threshold, the second threshold, and the suppressed speed depending on the classification of the object.

7. The travel management system according to claim 1, wherein
the management server is further configured to:
calculate an influence range of the object that influences travel of the vehicle;
when the influence range is in contact with the traffic route, determine whether or not a change of moving the traveling position of a contacting section on the traffic route in a direction away from the influence range is possible; and
when it is determined that the change is possible, move the traveling position of the contacting section in a direction away from the influence range.

8. The travel management system according to claim 7, wherein
the management server is further configured to, when the object is a moving object, set a movement prediction range of the moving object as the influence range.

9. A travel management method for managing travel of a vehicle in a predetermined area in cooperation with processing circuitry and one or more memories, including:
with respect to a passage of the vehicle in the predetermined area, manage a traffic route defining a traveling position of the vehicle;
detect an object in the predetermined area using a recognition sensor;
execute a process of calculating a vehicle speed profile based on a positional relationship between the detected object and the traffic route, the vehicle speed profile providing a vehicle speed condition to be followed by the vehicle at each position on the traffic route; and
when managing travel of a target vehicle, transmit the traveling position of at least a traveling section in which the target vehicle travels on the traffic route and the vehicle speed profile of the traveling section to a control system of the target vehicle.
